(19) United States
(12) Patent Application Publication
(10) Pub. No.: US 2005/0076112 A1
(43) Pub. Date: Apr. 7, 2005

(54) System and method for management of remote devices in a network

(76) Inventors: Govindan Ravindran, Toronto (CA); Michael A, Varley, Toronto (CA)

Correspondence Address: KATTEN MUCHIN ZAVIS ROSENMAN, 525 WEST MONROE STREET, CHICAGO, IL, 60661-3693, US

(21) Appl. No.: 10/473,342

(22) PCT Filed: Mar. 25, 2002
(86) PCT No.: PCT/CA02/00428

(30) Foreign Application Priority Data
Mar. 29, 2001 (CA) 2,342,540

(51) Int. Cl. G06F 15/173

(52) U.S. Cl. 709/224

(57) ABSTRACT

A system and method of managing devices connected to a network by restricted bandwidth links, where a restricted bandwidth link comprises a wireless or other link which has a relatively limited amount of bandwidth available and/or a link wherein bandwidth is relatively expensive. The network has one or more master agents executing which communicate with proxy agents upstream of the restricted bandwidth links and which maintain management information about the managed objects that is obtained from both network management services for the restricted links and from relatively simple servers running at the managed objects. Communication between the proxy agents and the servers is by way of a simple protocol and the master agent performs translations to and from more complicated management protocols used in other parts of the network and this simple protocol.

### FIELD OF THE INVENTION

The present invention relates to the management of remote devices in a network. More specifically, the present invention relates to a system and method for the management of remote devices which are connected to a telecommunications network, or the like, by one or more links with limited and/or expensive bandwidth, such as the management of customer premise equipment (CPE) in a wireless local loop system or the like.

### BACKGROUND OF THE INVENTION

As networks, and particularly TCP/IP networks such as the Internet, have grown in use and complexity, various systems and methods have been developed to manage the diverse components which make up such networks. One popular system and method for managing such networks is SNMP (Simple Network Management Protocol) which was developed by the Internet Engineering Task Force (IETF) and has been widely used since about 1993.

SNMP employs a client/server type relationship wherein each physical or logical device managed with SNMP, (typically referred to as a “managed object”), executes a server program (also referred to as the “SNMP agent”) that a management tool (typically referred to as the “SNMP client”) can communicate with. Managed objects can include almost any device connected to the network, such as routers, gateways, firewalls, concentrators, computers, terminals, etc.

Each SNMP server maintains a management information base (“MIB”) about the object it manages and the MIB contains at least a minimum set of defined statistical and control values for the managed object.

The SNMP client communicates as needed, usually from a remote location, with the SNMP server to obtain status information, set alarm conditions, etc. for the managed object. Due to its widespread use, most network devices support SNMP and SNMP servers are available for them.

While SNMP is widely used, some network and/or device developments were not foreseen by its creators and thus its operation/suitability may be less than desired in some circumstances. For example, wireless telecommunication networks, or telecommunication networks which include wireless links, have limited and/or expensive bandwidth which SNMP may make inefficient use of, by requiring relatively large amounts of information to be exchanged between the SNMP server and SNMP client over the links and/or requiring many exchanges of data from the server to the client on an ongoing, or on-demand, basis in normal use. Such exchanges can utilize a significant proportion of the total capacity of a wireless, or other bandwidth limited, link and/or can be expensive.

### SUMMARY OF THE INVENTION

It is an object of the present invention to provide a novel system and method for the management of remote devices in a network which obviates or mitigates at least some of the above-identified disadvantages of the prior art.

According to a first aspect of the present invention, there is provided a wireless local loop system comprising at least one base station and a plurality of customer premises equipment devices communicating with said base station by a shared radio link, comprising:
a radio resource manager monitoring the operating conditions of the shared radio link and obtaining usage and historical usage information for said radio link;
a customer premises server in each of said plurality of customer premises equipment devices;
a proxy agent at said base station to communicate with said customer premises servers over said shared radio link to request information from said customer premises equipment devices, to transmit management data to said customer premises equipment devices and to maintain a management information base for said customer premises equipment devices including usage and historical information obtained from said radio resource manager, information obtained from said customer premises equipment devices over said shared radio link and information requested from said customer premises equipment devices;
a master agent, associated with said base station, and operable to receive management information requests from a network and to obtain requested data from said management information base.

According to another aspect of the present invention, there is provided a method of managing devices connected to a network by a restricted bandwidth link, comprising the steps of:
(i) collecting and storing in a proxy agent operating upstream of said restricted bandwidth link, statistical information relating to operation of the restricted bandwidth link connecting a managed device to the network;
(ii) polling, at selected times, the managed device over said restricted bandwidth link for information with respect to the operation of the managed device and storing the information returned in said proxy agent;
(iii) receiving at a master agent a request for information about the managed device, said master agent identifying a proxy agent associated with the managed device and forwarding a request for the information to the identified proxy agent;
(iv) upon receipt of said request, the identified proxy agent determining if the requested information is stored in the proxy agent and responding to the master agent with said information if present and requesting said information from said managed device over said restricted bandwidth link if not present in said proxy agent and receiving and forwarding a response from said managed device to said master agent.

According to another aspect of the present invention, there is provided a system for managing a plurality of devices connected to a network by restricted bandwidth links, comprising:
at least one master agent upstream of said restricted bandwidth links and operable to receive and respond to requests for management information about at least one of said plurality of devices;
at least one proxy agent, upstream of said restricted bandwidth links, storing management information about at least one of said plurality of devices, said management information including information relating to the operation of said link obtained from said network, information relating to operation of said device obtained by polling said device at pre-selected intervals and information obtained from said device upon request;
a client executing on said at least one device and responsive to polling and other requests from said proxy agent to obtain and forward information to said proxy agent over said restricted bandwidth link.

### BRIEF DESCRIPTION OF THE DRAWINGS

Preferred embodiments of the present invention will now be described, by way of example only, with reference to the attached Figures, wherein:

FIG. 1 shows a prior art use of an SNMP client and an SNMP server to manage a device;

FIG. 2 shows a prior art method of managing a device connected to a network via a wireless link, by employing an SNMP proxy forwarder;

FIG. 3 shows a prior art method of managing a device connected to a network via a wireless link, by replicating an SNMP server within the network;

FIG. 4 shows a network system implementing a remote management method and system in accordance with an embodiment of the present invention;

FIG. 5 shows a representation of a master agent, proxy agent and clients in accordance with an embodiment of the present invention; and

FIG. 6 shows a representation of a proxy agent of FIG. 5.

### DETAILED DESCRIPTION OF THE INVENTION

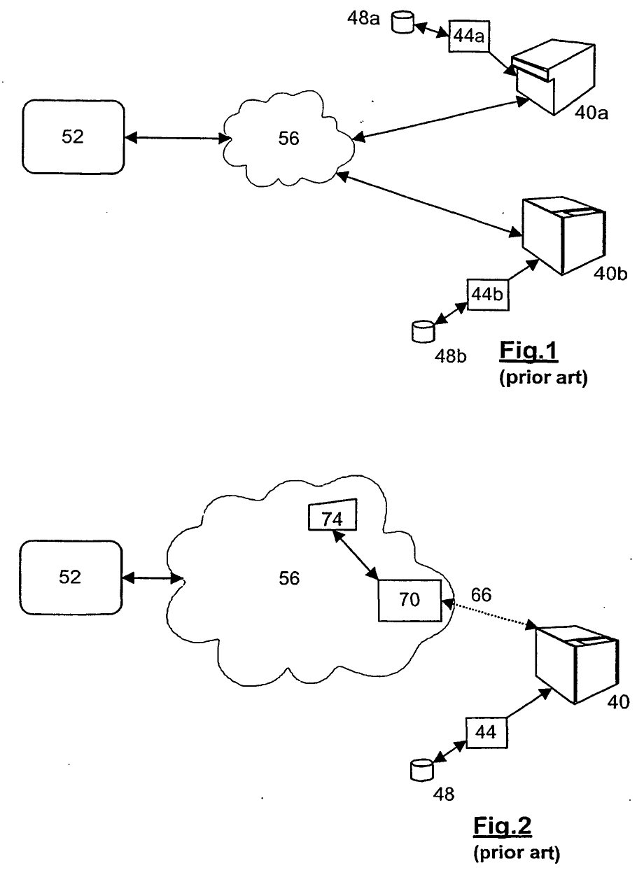

An example of a conventional SNMP deployment is illustrated in FIG. 1 where managed objects 40a, 40b each execute an SNMP server 44a, 44b respectively, each of which maintains a MIB 48a, 48b. An SNMP client 52 communicates with SNMP servers 44a, 44b through a network 56. SNMP client 52 can retrieve information, using the SNMP get( ) function, about managed objects 40a, 40b from their respective MIBs 48a, 48b, via SNMP servers 44a, 44b or can load information, using the SNMP set( ) function, into MIBs 48a, 48b to change operation of the managed objects 40a, 40b, as needed. Depending upon the specific managed object 40, MIB 48 can be stored on a disk drive, in RAM memory (Dynamic, Flash, etc.) or in any other suitable means.

As discussed above, despite the widespread acceptance and use of SNMP, it does suffer from some disadvantages. One disadvantage of SNMP is that SNMP is not a particularly bandwidth-efficient protocol. Significant amounts of bandwidth are used to transmit non-essential information header information, such as the tag and length information for each field, which is transmitted in every SNMP message. Further, multiple data descriptors are scattered throughout many messages. Also, SNMP variables are identified as byte strings, where each byte, set of bytes, or bit fields, corresponds to a particular node in the MIB database, and this leads to large data handles. Further, many SNMP messages may be transmitted across a network in normal operation, requiring a significant amount of bandwidth.

The designers of SNMP did not generally contemplate networks, such as wireless networks, with devices connected to the network via restricted bandwidth links. As used herein, the term “restricted bandwidth link” is intended to comprise a wireless or other link which has a relatively limited amount of bandwidth available and/or a link wherein bandwidth is relatively expensive. For such restricted bandwidth links, a benefit is obtained when reducing the amount of bandwidth otherwise required for managing devices.

Examples of devices typically connected by restricted bandwidth links can include, by way of example only, fixed wireless (wireless local loop) CPE devices, wireless information appliances or devices which use out-of-band bandwidth on telephone networks, such as alarm systems.

Another disadvantage of SNMP is that the SNMP server running on the managed device can be computationally expensive to implement, due to the inefficiencies and/or complexity of the SNMP protocol, and such computational complexity can result in a requirement for increased computational resources at the managed device, increasing the cost of such devices.

To date, the two methods of implementing SNMP management for managed objects connected to a network by a restricted bandwidth link have been to run a proxy forwarder application for each managed object and/or by replicating the SNMP servers and their MIBs in a host upstream of the restricted bandwidth links.

FIG. 2 shows an example of a network with a wireless link 66 which connects managed object 40 to network 56 through a network concentrator 70. Network concentrator 70 executes a proxy 74 which simply forwards any get( ) or set( ) SNMP commands it receives to the appropriate SNMP server 44 and passes received responses from the SNMP server 44 to the respective SNMP client 52 that issued the set( ) or get( ) command. The disadvantage of this approach is that it results in a significant use of bandwidth on wireless link 66 between concentrator 70 (and proxy 74) and the managed object 40, which is undesired.

FIG. 3 shows a prior art replication solution. In the Figure, the SNMP server 44, and its associated MIB 48, for a managed object 40 that is connected to the network via a wireless link 66, are replicated (as indicated in dashed line and with an “r” suffix) within network 56, such as in a wireless base station, upstream of the wireless link 66. The replicated server 44r, and MIB 48r, have all of the functionality of server 44 and the replicated server 44r polls server 44, over wireless link 66, to update the values stored in MIB 48r of the replicated server 44r. A get( ) command received at replicated server 44r will return the values that have been replicated to server 44r from server 44 while a set( ) command received at replicated server 44r from a SNMP client connected to network 56 will be forwarded to the server 44 running at managed object 40.

The disadvantages of this approach include the requirement for a relatively large amount of storage space in network 56 to be available for each replicated server 44r and MIB 48r (which may number in the hundreds in a wireless local loop system, for example) and that a trade off must be made between the currency of the information in replicated server 44r and the frequency of polling of the servers 44 to update the replicated servers 44r to the actual values at the managed objects 40. If the network operator requires a high degree of correspondence between the values in replicated server 44r and server 44, a large amount of the bandwidth of wireless link 66 will be required.

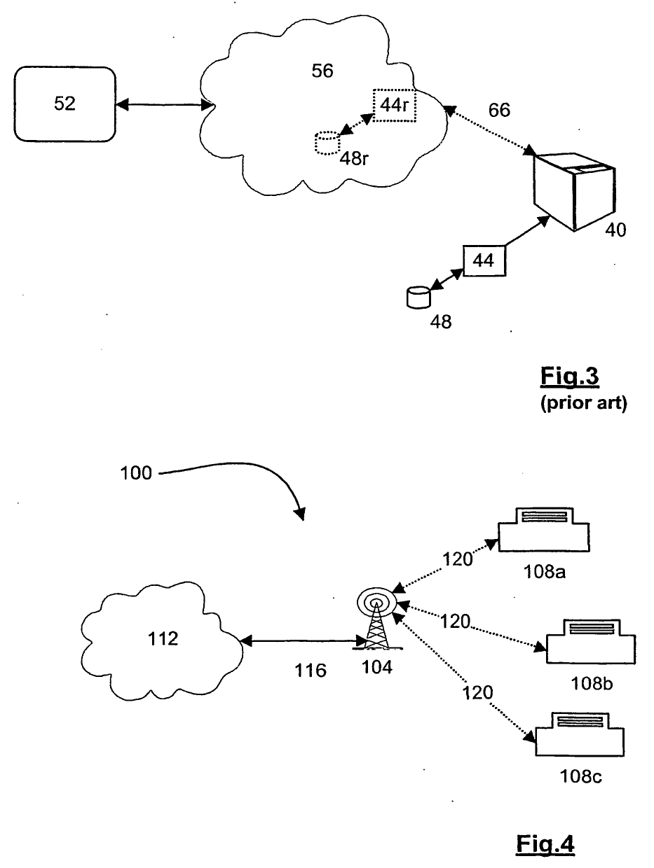

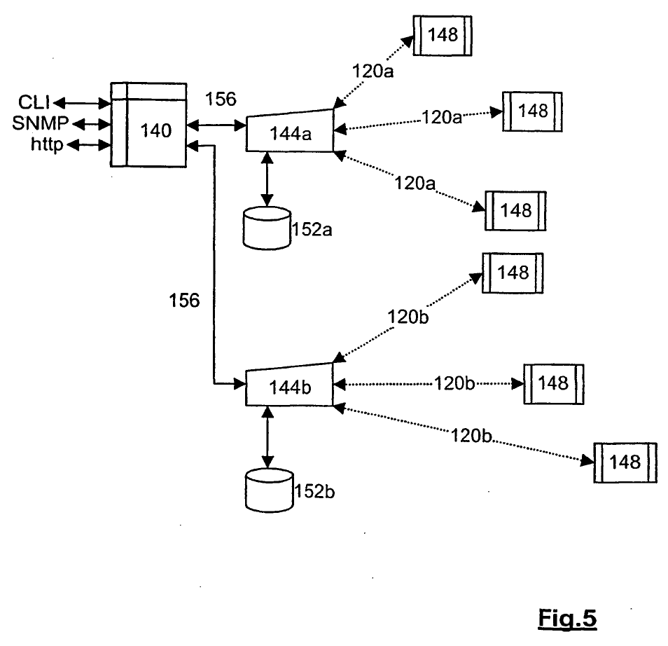

FIG. 4 shows a wireless local loop (WLL) system 100, which is sometimes also referred to as a wireless DSL system (wDSL), employing a network management system and/or method in accordance with an embodiment of the present invention. In the illustrated embodiment, for simplicity, system 100 includes a single wireless base station 104 and a plurality of customer premises equipment (CPEs) 108 although, as will be apparent to those of skill in the art, in actual use system 100 will usually also include a plurality of base stations 104.

Base station 104 is connected with appropriate gateways, switches and/or routers (not shown) to a network, or networks, 112 which ideally can provide both data and voice services via one or more backhaul links 116. Backhaul 116 can be any suitable link, or set of links, such as microwave links, T3 or OC3 land lines. Depending upon the number of CPEs 108 to be served, base station 104 can include a number of sectors, each sector having a directional antenna and a radio to serve the portion of CPEs 108 within the antenna beam. In circumstances wherein a relatively small number of CPEs 108 need to be served, base station 104 can be a single sector base station employing an omni-directional antenna to serve all CPEs 108 within range of base station 104. The use and deployment of multi-sector base stations is known to those of skill in the art.

A variety of telephony devices, not shown, such as telephones or facsimile machines, as well as data devices such as http browsers executing on personal computers or information appliances, also not shown, can be connected to each CPE 108. CPEs 108 communicate with base station 104 through a shared radio link 120 to enable the telephony devices and data devices connected to CPEs 108 to communicate with networks 112. In a single sector base station 104, shared link 120 is shared between all of the CPE 108 equipment served by the base station 104 and, in a multi-sector base station 104, shared link 120 is shared between the CPEs 108 in the antenna path of the respective sector. While shared link 120 can be channelized, to dedicate an amount of link resources to various CPEs 108, the total amount of resources (bandwidth) of shared link 120 is fixed and must be shared among the CPEs 108 in a sector or, in the case of a single sector base station 104, shared amongst the CPEs 108 served by the base station 104 and thus radio link 120 is a restricted bandwidth link.

System 100 includes radio resource management (RRM) services to manage shared radio link 120 and to ensure effective and appropriate use of shared link 120 in accordance with the desires of the operator of system 100 and the needs of its users and the requirements of the particular communications. For example, voice communications can tolerate reasonable levels of errors, but do not tolerate large end to end latencies, while many data applications such as http browsers or ftp file transfers cannot tolerate error levels which would be acceptable to voice communications, but can tolerate end to end latencies significantly larger than those that can be accommodated by voice communications. Accordingly, a network operator can have the RRM services prioritize usage of the transmission resources (bandwidth) on shared link 120 such that voice communications are given priority over data communications to ensure that voice communications do not experience unacceptable end to end latencies, etc. and to maximize the operator's revenue (assuming voice communications produce a better revenue stream than data communications). Also, the RRM services monitor network operations over shared link 120 and track events like frame errors, requests to retransmit packets, etc. and adjust operation of shared link 120 accordingly.

The result of the operation of the RRM services is a coupling of the base station 104, or sectors therein, and the CPEs 108 that are served by it whereby a variety of usage and historical information can be maintained by the RRM services. The RRM services can be located in a base station 104 or can be located at any suitable location in system 100. In a presently preferred embodiment, each base station 104 will execute an instance of the RRM services. In the case of multi-sector base stations 104, it is contemplated that an instance of the RRM services will be executed for each sector in a base station 104.

FIG. 5 shows an embodiment of the present invention wherein a master agent 140 is associated with each base station 104, a proxy agent 144a, 144b is associated with each base station sector (in this example two sectors are shown but more or fewer sectors can be provided and in the case of a single sector base station 104, only a single proxy agent 144 is provided) and a CPE server 148 is associated with each CPE 108. Each base station sector communicates with its CPE servers 148, and their associated CPEs 108, via a respective shared radio link 120a, 120b (the subscripts ‘a’ and ‘b’ indicating different sectors served by the radio link 120).

Each proxy agent 144a, 144b operates to maintain a respective MIB 152a, 152b. Preferably, master agent 140 executes in base station 104, as do proxy agents 144a, 144b, and MIBs 152a, 152b and each CPE server 148 executes within its respective CPE 108. While there are advantages to having master agent 140 execute at the same location as the radio management services, it is contemplated that master agent 140 can execute anywhere within system 100, if desired, as can proxy agents 144, and master agent 140 communicates with proxy agents 144 through a communication port 156, which can be a standard network link or any other suitable communication link.

In a present embodiment, master agent 140 acts as an SNMP server and is accessed by SNMP clients in a conventional manner. However, it is also contemplated that master agent 140 can also be accessed via a command line interface (“CLI”), an http interface or any other interface as desired by a network administrator. In the present embodiment, master agent 140 communicates with proxy agents 144 via SNMP through port 156, although a different interface between master agent 140 and proxy agents 144 can be employed if desired.

In the present embodiment, wherein SNMP is used as the interface protocol between master agent 140 and proxy agents 144 through port 156, master agent 140 receives all management requests from SNMP (CLI, http or other) clients for information with respect to CPEs 108 and/or base station 104 and either passes the received SNMP request to the appropriate proxy agent 144, or converts a received non-SNMP (i.e.—CLI, http, etc.) request for management information into SNMP and then passes the resulting request to the appropriate proxy agent 144.

It is also contemplated that, in some circumstances. (such as if base stations 104 are single sector stations), master agent 140 and proxy agent 144 can be combined. In such a case, upstream devices communicate with the combined master agent/proxy which will perform all necessary translations and communications.

If an interface protocol other than SNMP is used to communicate between master agent 140 and proxy agents 144 through port 156, then master agent 140 will translate, as necessary, any received request for management information to the appropriate interface protocol to be passed to proxy agents 144 through port 156.

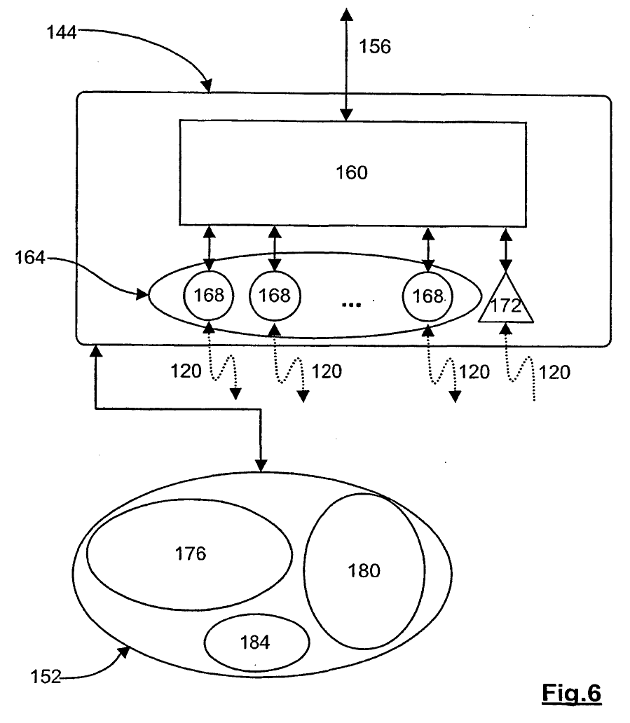

A proxy agent 144 is shown in more detail in FIG. 6. Proxy agent 144 includes a control agent 160 which receives SNMP (or another interface protocol) requests from master agent 140 over communications port 156 and transmits SNMP (or another interface protocol) messages and/or replies to master agent 140 over communications port 156, as described in more detail below. Proxy agent 144 also includes a pool 164 of client requesters 168, each of which can communicate with a CPE server 148 in a CPE 108 via shared link 120, and a warning listener 172, described in more detail below, which listens to shared link 120 to receive any warning messages from any CPE 108 served by proxy agent 144.

MIB 152, maintained by the proxy agents 144, includes an instrumentation table of values for each CPE server 148, and thus for each active CPE 108 served by the base station 104 (or in a multi-sectored base Station, for each active CPE 108 served by a sector). This instrumentation table includes a unique identifier for each active CPE 108, which can be a serial number, cryptographic authenticator or any other suitable method of uniquely identifying CPEs 108 within system 100.

As mentioned before, system 100 includes RRM services to manage shared link 120. The RRM services cooperate with proxy agents 144 to ensure that an entry is added to the instrumentation table in MIB 152 as each CPE 108 to be served by a proxy agent 144 becomes active (either by being turned on within the area served by proxy agent 144 or by being moved into that area from another area, i.e. the CPE 108 is moved, physically or logically (via handoff) from one sector of a base station 104 to another, etc.) and removing entries from MIB 152 as each CPE 108 become inactive (either by being tuned off or by being moved out of the area served by the base station or base station sector).

The instrumentation table in MIB 152 includes information of interest, such as the basic set of standard SNMP values, expected by a network operator. There are three general categories of information available from the instrumentation table. The first category of information 176 are those values which are available from, and provided by, the RRM services of system 100. For example, values relating to bit, frame and/or packet error rates and/or retransmission requests over shared link 120 are known, or derived, by the RRM services in the normal course of operation and are stored in the instrumentation table in MIB 152, as appropriate.

The second category of information 180 is statistical information values that are not normally available to the RRM services and are instead obtained, from time to time, from CPE servers 148 for their associated CPEs 108. Examples of such information include average, max and min CPU loading, memory utilization, etc. within a CPE 108.

The third category of information 184 is information values which are current and time sensitive and must be retrieved from a CPE 108 upon request. Examples of such information would include CPE status, diagnostic results, etc.

Communication between the proxy agent 144 and the CPE servers 148 is achieved via client requesters 168. As mentioned above, each proxy agent 144 has a pool 164 of several client requesters 168 which can be accessed by control agent 160. A pool 164 of such requesters 168 is presently preferred, versus instantiating requesters 168 when needed, as it places an upper limit on the amount of resources of shared link 120 that can be occupied by management (SNMP, etc.) requests and, by instantiating the entire pool 164 of requesters 168, performance is enhanced with respect to the alternative of instantiating the requesters 168 when needed as the overhead and/or delay involved in instantiating the requesters is avoided.

When a value in the instrumentation table in MIB 152 needs to be updated (i.e.—for information in the second category mentioned above) or current information (i.e.—information in the third category mentioned above) needs to be obtained, control agent 160 requests a client requester 168. Similarly, if a management value (such as an alarm or operating parameter) in a CPE 108 is to be changed, for example because a SNMP set( ) command has been received at master agent 140, control agent 160 requests a client requester 168.

In either case, when a client requester 168 is available from pool 164, the command and/or parameters are passed from control agent 160 to the client requester 168 and a suitable message is created by the client requester 168 and is transmitted to the CPE server 148 over shared link 120.

As one of the intents of the present invention is to make efficient use of the resources of shared link 120, the presently preferred message format is simple and compact, comprising: a header indicating the length of the message; an identifier for the command being sent; and any parameters required by the command. In the present implementation, the message header comprises four bytes, the command identifier comprises two bytes and the command parameters can comprise as many bytes as required. The present invention is not limited to this configuration and/or these field sizes and other message configurations and sizes that can be employed will be apparent to those of skill in the art. In the present embodiment, which employs internet protocol (IP) as a transmission protocol on shared link 120, the message is placed in the payload of a TCP/IP packet addressed to the CPE 108 of interest.

A CPE agent 148 receiving a message from a client requester 168, processes the message to extract the command, and any associated parameters, and then acts on the command. If a reply is required by the client requester 168, as is implicitly defined by the nature of the command received by the CPE agent 148, a return message is transmitted by CPE agent 148 to the client requester 168 over shared link 120.

In a presently preferred embodiment of the invention, a reply message comprises: a header, indicating the length of the message; the unique identifier value of the CPE 108 sending the reply; and a response payload. In a present implementation, the header is four bytes in length, the unique identifier is twelve bytes in length and the response comprises as many bytes as required. The response is addressed to the address of the client requester 168 which transmitted the original request and once that client requester 168 has received the response, it verifies the identity of the responding CPE 108.

In system 100, it is contemplated that IP addresses will be re-assigned/reused as CPEs 108 are activated, deactivated and moved between areas served by different base stations 104 and/or base station sectors. Further, as the RRM services will only update the instrumentation table in MIB 152 from time to time, it is possible that a CPE 108 can be assigned an IP address previously used by a different CPE 108, which is no longer being served by the base station 104, and that the instrumentation table will not be immediately updated to reflect this change. Therefore, when a response message is received from a CPE agent 148, client requester 168 compares the received unique identifier with that stored in the instrumentation table and, if they do not agree, the response is discarded and an error message is provided to control agent 160 which will then have the incorrect entry in the instrumentation table removed. Then, information will be collected and/or obtained in the normal course for the new CPE 108 assigned to that IP address.

If the unique identifier is correct, client requester 168 forwards the response data to control agent 160 which ensures that the values in the instrumentation table are updated accordingly and/or a response is provided to a requesting SNMP agent via master agent 140. The client requester 168 is then returned to the pool 164 of such requesters. If no reply was required by the nature of the command sent via a requester 168, then that requester 168 will be returned to the pool 164 of requesters as soon as the transmission of its command is completed.

For information which requires updates from time to time (the second category of information referred to above), control agent 160 can poll CPE agents 148 at appropriate intervals and/or as client requesters 168 are available.

Warning listener 172 is continuously monitored by control agent 160. If a CPE server 148 needs to transmit an alarm or other warning message to control agent 160, an appropriate message is transmitted to warning listener 172 which will then process the message appropriately, in the presently preferred embodiment by sending an SNMP trap message to control agent 160. If such alarms or warnings require communication with the CPE 108, master agent 160 will obtain a requester 168 from pool 164 and transmit the required communication to CPE server 148 associated with the CPE 108.

As CPE servers 148 do not have to communicate in a complicated protocol such as SNMP, and as a large amount of management information is obtained/derived from the RRM services without reference to the CPE servers 148, CPE servers 148 can have a relatively simple design which does not unduly burden the computational resources of CPEs 108.

Some examples of the data included in the instrumentation table in MIB 152 include: a unique identifier of the CPE 108; the IP address presently assigned to the CPE 108; the version of the software presently executing on the CPE 108; the processor loading of the CPU in a CPE 108; the amount of free memory in a CPE 108; a timestamp indicating the last time a piece of relevant information was updated in MIB 152, e.g.—a timestamp can be provided to indicate the last time the CPU loading data was updated; etc.

The present invention overcomes several of the disadvantages of the prior art use of SNMP with respect to networks having restricted bandwidth links. In particular, information is obtained from RRM or other management services running upstream of the restricted bandwidth links and/or is obtained from managed devices connected to the network by restricted bandwidth links, via relatively bandwidth efficient protocols, when required or at predefined times. The system is transparent to clients, managed objects, etc. and can be used with a variety of protocols, such as SNMP, as such protocols communicate with a master agent which hides details of the system from such protocols. The CPE servers can be rather simple, as they are not required to communicate in complex protocols such as SNMP and some of the information they would otherwise be required to collect and report is instead derived from network management services executing within the network, in the present embodiment these management services are radio resource management services managing the usage and performance of shared radio links.

The above-described embodiments of the invention are intended to be examples of the present invention and alterations and modifications may be effected thereto, by those of skill in the art, without departing from the scope of the invention which is defined solely by the claims appended hereto.

1. A wireless local loop system comprising at least one base station and a plurality of customer premises equipment devices communicating with said base station by a shared radio link, comprising:
a radio resource manager monitoring the operating conditions of the shared radio link and obtaining usage and historical usage information for said radio link;
a customer premises server in each of said plurality of customer premises equipment devices;
a proxy agent at said base station to communicate with said customer premises servers over said shared radio link to request information from said customer premises equipment devices, to transmit management data to said customer premises equipment devices and to maintain a management information base for said customer premises equipment devices including usage and historical information obtained from said radio resource manager, information obtained from said customer premises equipment devices over said shared radio link and information requested from said customer premises equipment devices;
a master agent, associated with said base station, and operable to receive management information requests from a network and to obtain requested data from said management information base.

2. The wireless local loop system as claimed in claim 1 wherein said master agent and said proxy agent are combined and are the same element.

3. A method of managing devices connected to a network by a restricted bandwidth link, comprising the steps of:
(i) collecting and storing in a proxy agent, operating upstream of said restricted bandwidth link, statistical information relating to operation of the restricted bandwidth link connecting a managed device to the network;
(ii) polling, at selected times, the managed device over said restricted bandwidth link for information with respect to the operation of the managed device and storing the information returned in said proxy agent;
(iii) receiving at a master agent a request for information about the managed device, said master agent identifying a proxy agent associated with the managed device and forwarding a request for the information to the identified proxy agent;
(iv) upon receipt of said request, the identified proxy agent determining if the requested information is stored in the proxy agent and responding to the master agent with said information if present and requesting said information from said managed device over said restricted bandwidth link if not present in said proxy agent and receiving and forwarding a response from said managed device to said master agent.

4. The method of claim 3 further comprising the step of said master agent translating said received request from a first protocol to a second protocol in which the request is forwarded to said identified proxy and said master agent translating information received from said proxy agent in said second protocol into said first protocol to respond to said request for information.

5. The method of claim 4 wherein said first protocol is SNMP.

6. The method of claim 3 wherein said information stored in said proxy is stored in a management information base.

7. The method of claim 3 wherein said master agent and said proxy agent are combined and are the same element.

8. A system for managing a plurality of devices connected to a network by restricted bandwidth links, comprising:
at least one master agent upstream of said restricted bandwidth links and operable to receive and respond to requests for management information about at least one of said plurality of devices;
at least one proxy agent, upstream of said restricted bandwidth links, storing management information about at least one of said plurality of devices, said management information including information relating to the operation of said link obtained from said network, information relating to operation of said device obtained by polling said device at pre-selected intervals and information obtained from said device upon request;
a client executing on said at least one device and responsive to polling and other requests from said proxy agent to obtain and forward information to said proxy agent over said restricted bandwidth link.

9. The system of claim 8 wherein said proxy agent translates requests received from said master agent in a first protocol into a second protocol for transmission to said device over said restricted bandwidth link, said client receiving and responding to said requests in said second protocol and said proxy translating responses received in said second protocol into said first protocol for responding to said master agent.

10. The system as claimed in claim 8 wherein said master agent and said proxy agent are combined and are the same element.
